(19) United States
(12) Patent Application Publication
(10) Pub. No.: US 2026/0050573 A1
(43) Pub. Date: Feb. 19, 2026

(54) INFORMATION PROCESSING DEVICE, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventor: HIROSHI YAMAZAKI, Tokyo (JP)

(21) Appl. No.: 19/038,765

(22) Filed: Jan. 28, 2025

(30) Foreign Application Priority Data
Feb. 7, 2024 (JP) 2024-017435

(51) Int. Cl. G06F 16/13; G06F 16/14

(52) U.S. Cl. CPC G06F 16/13; G06F 16/156

(57) ABSTRACT

An information processing device comprising: a storage unit configured to store file information regarding a file; and a control unit configured to acquire the file information and display the file information and a file name on a display unit, wherein in a case where the file is a file inside which a recording date and time cannot be stored, the control unit acquires a recording date and time from the file name of the file, adds the acquired recording date and time to the file information, and displays the file information on the display unit.

### BACKGROUND OF THE INVENTION

### Field of the Invention

The present invention relates to an information processing device, an information processing method, and a non-transitory computer-readable storage medium.

### Description of the Related Art

There are known information processing devices that, when displaying a list of files, display file information such as the recording date and time together with file names. When such an information processing device displays a list of image files, recording dates and times acquired from metadata included in the files is displayed as the file information.

Furthermore, Japanese Patent No. 6312008 discloses a technology for including the creation time of an image in the file name of an audio file.

### SUMMARY OF THE INVENTION

Here, the background technology disclosed in Japanese Patent No. 6312008 does not mention displaying file information for an audio file. In the case where an audio file does not have metadata, an information processing device generally displays the creation date and time or the update date and time of the file as the recording date and time of the file. However, the recording date and time may differ from the creation date and time or the update date and time, and the accurate recording date and time may not be presented to the user.

In view of this, the present invention provides a technology that enables the recording date and time of a file such as an audio file to be accurately displayed as file information.

According to one aspect of the present disclosure, there is provided an information processing device comprising: a storage unit configured to store file information regarding a file; and a control unit configured to acquire the file information and display the file information and a file name on a display unit, wherein in a case where the file is a file inside which a recording date and time cannot be stored, the control unit acquires a recording date and time from the file name of the file, adds the acquired recording date and time to the file information, and displays the file information on the display unit.

According to another aspect of the present disclosure, there is provided an information processing method comprising: storing file information regarding a file; and acquiring the file information and displaying the file information and a file name on a display unit, wherein in the displaying, in a case where the file is a file inside which a recording date and time cannot be stored, a recording date and time is acquired from the file name of the file, the acquired recording date and time is added to the file information, and the acquired recording date and time is displayed on a display unit.

According to another aspect of the present disclosure, there is provided a non-transitory computer-readable storage medium storing a computer program that, when read and executed by a computer including a storage unit storing file information regarding a file, causes the computer to function as: a control unit configured to acquire the file information and display the file information and a file name on a display unit, wherein in a case where the file is a file inside which a recording date and time cannot be stored, the control unit acquires a recording date and time from the file name of the file, adds the acquired recording date and time to the file information, and displays the acquired recording date and time on the display unit.

Further features of the present invention will become apparent from the following description of exemplary embodiments (with reference to the attached drawings).

### BRIEF DESCRIPTION OF THE DRAWINGS

FIG. 1 is a schematic diagram showing a configuration of a transfer system according to an embodiment.

FIG. 2A is a block diagram showing an example of the hardware configuration of an image capturing device according to the embodiment.

FIG. 2B is a perspective view of the image capturing device seen obliquely from the front.

FIG. 2C is a perspective view of the image capturing device seen obliquely from behind.

FIG. 3 is a diagram showing a file structure of files stored in a recording medium of the image capturing device according to the embodiment.

FIG. 4 is a block diagram showing a hardware configuration of a communication device according to the embodiment.

FIG. 5 is a functional block diagram showing a software configuration of the communication device according to the embodiment.

FIG. 6A shows a function selection screen displayed after a transfer application has been launched and is connected to the image capturing device.

FIG. 6B1 shows a list display screen displaying a list of files recorded in the image capturing device connected to the communication device.

FIG. 6B2 shows a list display screen displaying a list of files recorded in the image capturing device connected to the communication device.

FIG. 6C1 shows a list display screen with save buttons and a cancel button superimposed thereon.

FIG. 6C2 is a list display screen with a save button and a cancel button superimposed thereon.

FIG. 6D shows a function selection screen with an open button and a cancel button superimposed thereon.

FIG. 6E shows a file selection screen provided by an OS.

FIG. 6F shows a file selection screen provided by a control unit.

FIG. 6G shows a selected file list screen displaying a list of selected files.

FIG. 7 shows a processing sequence for displaying a list display screen on the communication device according to the embodiment.

FIG. 8 shows a flow of processing for generating a list display screen, which is executed by the communication device of the embodiment.

FIG. 9A shows a flow of processing executed by the image capturing device of the embodiment when a communication command is received.

FIG. 9B shows a flow of processing executed by the image capturing device of the embodiment when a communication command is received.

FIG. 10 is a schematic diagram of directory entries of the communication device according to the embodiment.

FIG. 11 shows a flow of processing for generating a selected file list screen, which is executed by the communication device of the embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate.

Furthermore, in the attached drawings, the same reference numerals are given to the same or similar configurations, and redundant description thereof is omitted.

### Embodiment

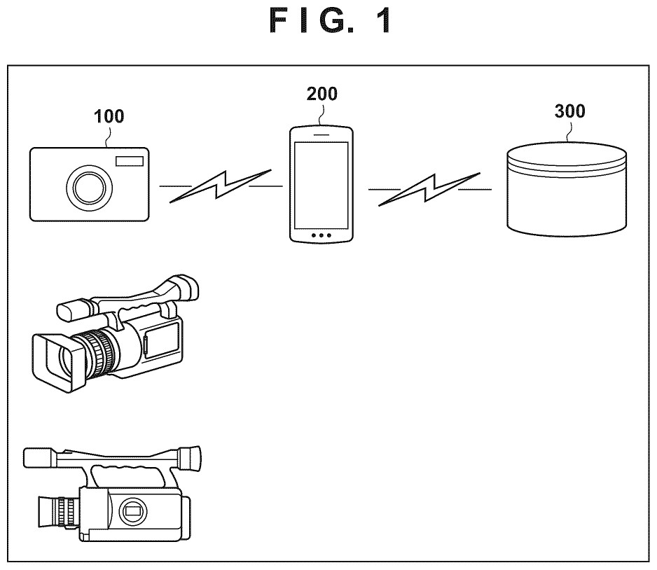

FIG. 1 is a schematic diagram illustrating the configuration of a transfer system according to an embodiment. As shown in FIG. 1, the transfer system of the embodiment includes an image capturing device 100, a communication device 200, and a server 300. The image capturing device 100 is, for example, a digital camera that captures an image of a subject and generates image data such as still images and moving images by converting light into electrical data. The communication device 200 is, for example, a portable mobile terminal, and is an information processing device that has a communication function, such as a smartphone or a computer. The server 300 is a computer disposed at a connection destination via a communication network such as the Internet, and is a storage device capable of storing data such as image data and audio data. Note that the term “image”may include still images, moving images, videos, and data thereof.

In FIG. 1, the image capturing device 100 and the communication device 200 are connected by wired communication or wireless communication, via a connection method such as a wired cable or Wi-Fi. Therefore, the image capturing device 100 can transfer generated image files and audio files to the communication device 200. The communication device 200 and the server 300 are connected via a communication method such as mobile data communication. The communication device 200 can transfer stored information to the server 300 by communicating with the server 300 by FTP communication or the like.

However, the system configuration is not limited to this. For example, the image capturing device 100, the communication device 200, and the server 300 may be connected to the same network via access points, and may not use mobile data communication. In this case, the devices may realize file transfer processing via the network.

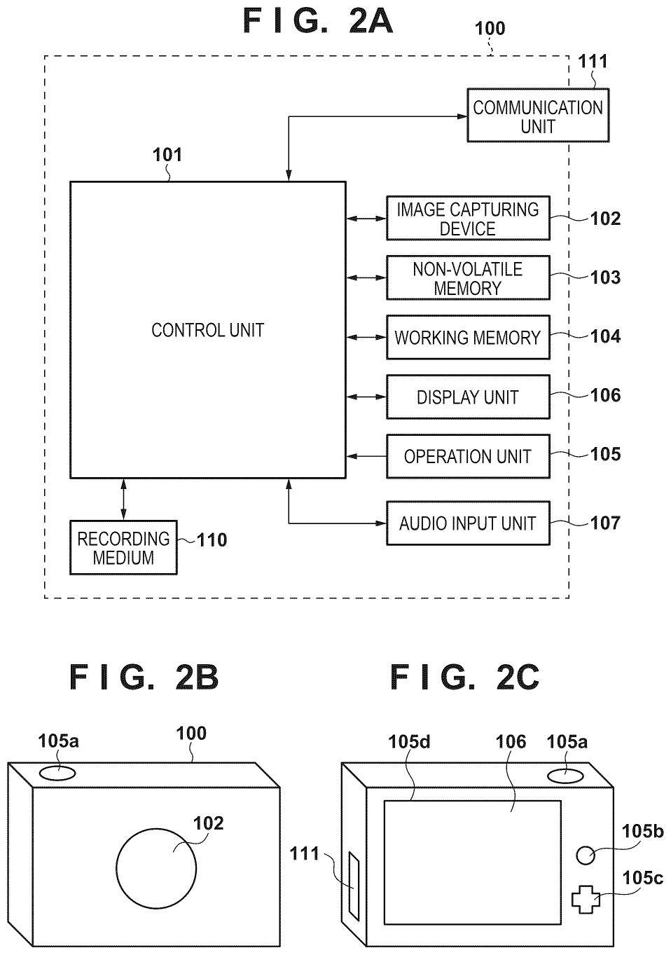

FIG. 2A is a block diagram showing an example of the hardware configuration of the image capturing device 100 of the present embodiment. Although a digital camera will be described as an example of the image capturing device here, the image capturing device is not limited to this. For example, the image capturing device may be an information processing device such as a portable media player, a so-called tablet device, or a personal computer. The image capturing device 100 includes a control unit 101, an image capturing unit 102, a non-volatile memory 103, a working memory 104, an operation unit 105, a display unit 106, an audio input unit 107, a recording medium 110, and a communication unit 111.

The control unit 101 controls units of the image capturing device 100 in accordance with input signals and a later-described program. Note that instead of the control unit 101 performing overall control of the device, overall control of the device may be controlled by processing shared among a plurality of hardware devices. The control unit 101 includes, for example, a central processing unit (CPU). Instead of or in addition to a CPU, the control unit 101 may include another processor, such as a micro processing unit (MPU), a graphics processing unit (GPU), or a quantum processing unit (QPU). The control unit 101 realizes various later-described functions by, for example, one or more processors reading out a program stored in the non-volatile memory 103 and loading the program in the working memory 104. Some or all of the functions realized by the control unit 101 may be realized by one or more circuits such as an application specific integrated circuit (ASIC) or a field programmable gate array (FPGA).

The image capturing unit 102 is constituted by, for example, an optical lens unit, an optical system that controls the aperture, zoom, focus, and the like, and an imaging element for converting light (an image) passing through the optical lens unit into an electrical image signal. In general, a complementary metal oxide semiconductor (CMOS) or a charge coupled device (CCD) is used as the imaging element. Under control of the control unit 101, the image capturing unit 102 uses the imaging element to convert subject light focused by a lens included in the image capturing unit 102 into an electrical signal, performs noise reduction processing and the like, and outputs digitally-converted digital data as moving image data. The image capturing device 100 of the present embodiment records image data, including captured still image data and moving image data, on the recording medium 110.

The non-volatile memory 103 is a non-volatile memory in which data can be electrically erased and recorded. The non-volatile memory 103 stores a later-described program executed by the control unit 101, meta template information, and the like. Note that the non-volatile memory 103 may store image data and audio data. The non-volatile memory 103 is, for example, a storage device such as a read only memory (ROM), a hard disk drive (HDD), or a solid state drive (SSD).

The working memory 104 is used as, for example, a buffer memory for temporarily storing still image data and moving image data captured by the image capturing unit 102, a memory for displaying moving images on the display unit 106, and a working area for the control unit 101. The working memory 104 is, for example, a random access memory (RAM).

The operation unit 105 is used for accepting instructions given to the image capturing device 100 by a user. The operation unit 105 includes, for example, a power button for the user to instruct the turning ON and OFF of the power of the image capturing device 100, a release switch for instructing the start and stop of image capturing, and a playback button for instructing the playback of moving image data. Furthermore, the operation unit 105 includes a dedicated connection button for starting communication with an external device via the later-described communication unit 111. The operation unit 105 also includes a touch panel provided on the display unit 106 described below.

The display unit 106 displays, for example, a viewfinder image during image capturing, images including captured still images and moving images, and text for interactive operations. The display unit 106 is, for example, an image display device such as a liquid crystal display device or an organic electro luminescence (EL) display device. Note that the display unit 106 does not necessarily have to be built into the image capturing device 100. The image capturing device 100 can also be connected to an internal or external display unit 106, and need only have at least a display control function for controlling the display of the display unit 106.

The audio input unit 107 is a device such as a microphone for the input of audio information. The audio input unit 107 converts audio information into audio data, and records the audio data on the recording medium 110 in an audio file format.

The recording medium 110 records moving image data output from the image capturing unit 102 and audio data output from the audio input unit 107. The recording medium 110 is, for example, a flash memory. The recording medium 110 may be configured to be detachable from the image capturing device 100, or may be built into the image capturing device 100. In other words, the image capturing device 100 need only be able to at least access the recording medium 110.

The communication unit 111 is an interface for connecting the image capturing device 100 to an external device via a network or the like. The image capturing device 100 of the present embodiment performs data communication with an external device via the communication unit 111. For example, the image capturing device 100 transmits image data, including still image data and moving image data generated by the image capturing unit 102 and audio data generated by the audio input unit 107, to an external device via the communication unit 111.

Note that in the present embodiment, the communication unit 111 includes an interface for performing communication with an external device via a so-called wireless LAN in accordance with the IEEE 802.11 standard. The communication unit 111 also includes a universal serial bus (USB) interface for connecting to an external device via a USB cable. The control unit 101 controls the communication unit 111 to realize wireless communication and wired communication with an external device.

The communication unit 111 of the image capturing device 100 in the present embodiment has an access point mode (hereinafter, AP mode) for operating as an access point in infrastructure mode. Furthermore, the communication unit 111 has a client mode (hereinafter, CL mode) for operating as a client in infrastructure mode. When the communication unit 111 operates in the CL mode, the image capturing device 100 in the present embodiment can operate as a CL device in infrastructure mode. When operating as a CL device, the image capturing device 100 can join a network formed by a nearby AP device by connecting to the AP device. In addition, when the communication unit 111 operates in the AP mode, the image capturing device 100 in the present embodiment can also operate as a simple AP, which is a type of AP that has limited functionality. When the image capturing device 100 operates as a simple AP, the image capturing device 100 forms a network itself. Devices in the vicinity of the image capturing device 100 recognize the image capturing device 100 as an AP device, and are able to join the network formed by the image capturing device 100. It is assumed here that a program for causing the image capturing device 100 to operate as described above is stored in the non-volatile memory 103.

Note that although the image capturing device 100 in the present embodiment is a simple AP, which is a type of AP that does not have a gateway function for transferring data received from a CL device to an Internet provider or the like. Therefore, even if the image capturing device 100 receives data from another device participating in the network formed by the image capturing device 100, the image capturing device 100 cannot transfer the received data to a network such as the Internet.

Next, the external appearance of the image capturing device 100 will be described. FIGS. 2B and 2C are diagrams showing an example of the external appearance of the image capturing device 100. FIG. 2B is a perspective view of the image capturing device 100 as viewed obliquely from the front. FIG. 2C is a perspective view of the image capturing device 100 as viewed obliquely from behind. The operation unit 105 includes a release switch 105a, a playback button 105b, a directional key 105c, and a touch panel 105d. The display unit 106 displays images obtained as a result of image capturing performed by the image capturing unit 102.

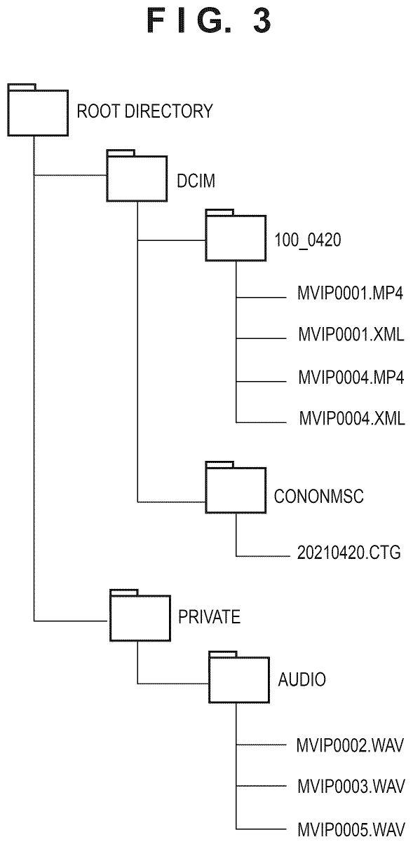

FIG. 3 is a diagram showing a file structure of files stored in the recording medium 110 of the image capturing device 100. It is assumed here that the recording medium 110 has been formatted with a file system such as extended file allocation table (exFAT) that can be referenced from various operating systems (OSes).

As shown in FIG. 3, the control unit 101 records moving image data generated by the image capturing unit 102 in the MP4 file format under the directory “100_0420” (the last four characters indicate the current date) under the directory “DCIM”. The last four characters in the directory name “100_0420” indicate the current date. Furthermore, the control unit 101 records metadata information of the moving image data in an extensible markup language (XML) file format based on meta template information read from the non-volatile memory 103. The metadata information is information used for data management at a delivery destination to which the moving image data is sent, and includes information such as a category, a title, and a comment of the moving image data. The metadata information is input with corresponding tags in the XML file.

The control unit 101 records audio data generated by the audio input unit 107 in the WAV file format under the “AUDIO” directory under the “PRIVATE” directory.

Furthermore, when moving image data and audio data are generated by the image capturing unit 102 and the audio input unit 107, the control unit 101 generates or updates a catalog file for file management under the “CANONMSC” directory under the “dCIM” directory. The control unit 101 records file information, including the recording date and time of the file recorded on the recording medium 110, in the catalog file.

As described above, the recording medium 110 stores moving image files recorded in the MP4 file format, metadata files recorded in the XML file format, audio files recorded in the WAV file format, and a catalog file that manages file information of the files.

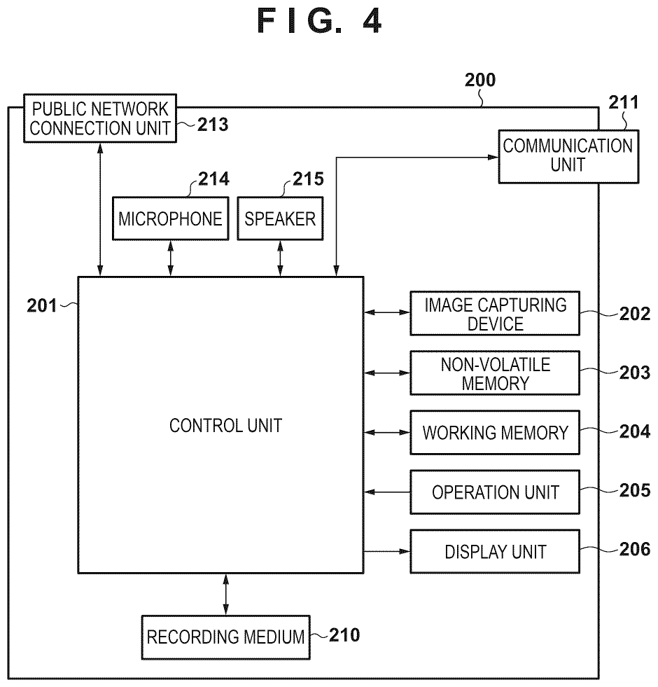

FIG. 4 is a block diagram showing an example of the hardware configuration of the communication device 200 of the present embodiment. Although a portable mobile terminal will be described here as an example of the communication device 200, the communication device 200 is not limited to this. For example, the communication device 200 may be a digital camera with a wireless communication function, a tablet device, or a personal computer. The communication device 200 includes a control unit 201, an image capturing unit 202, a non-volatile memory 203, a working memory 204, an operation unit 205, a display unit 206, a recording medium 210, a communication unit 211, a public network connection unit 213, a microphone 214, and a speaker 215.

The control unit 201 controls units of the communication device 200 in accordance with input signals and a later-described program. Note that instead of the control unit 201 performing overall control of the device, overall control of the device may be controlled by processing shared among a plurality of hardware devices. The control unit 201 has one or more processors, such as a CPU, an MPU, a GPU, or a QPU. The control unit 201 realizes various functions by, for example, reading out a program stored in the non-volatile memory 203 and loading the program to the working memory 104.

The image capturing unit 202 converts subject light focused by a lens included in the image capturing unit 202 into an electrical signal, performs noise reduction processing, AD conversion, and the like, and generates and outputs image data including still image data and moving image data, which are digital data. Image data such as captured moving image data is stored in a buffer memory, then subjected to predetermined calculation by the control unit 201, and then recorded on the recording medium 210.

The non-volatile memory 203 is a non-volatile memory in which data can be electrically erased and recorded. The non-volatile memory 203 is a storage device such as an HDD or SSD. The non-volatile memory 203 stores an OS, which is basic software executed by the control unit 201, and applications that cooperate with the OS to realize applied functions. The non-volatile memory 203 may store image data, audio data, and the like. The non-volatile memory 203 stores a transfer application for performing communication with the image capturing device 100 and the server 300. The non-volatile memory 203 stores a file management application and an image management application that manage moving image files and audio files output from the image capturing device 100.

The working memory 204 is used as, for example, an image display memory for the display unit 206 and as a work area for the control unit 201. The working memory 204 is, for example, a RAM.

The operation unit 205 is used for accepting instructions given to the communication device 200 by a user. The operation unit 205 includes, for example, operation members such as a power button for the user to instruct the turning ON and OFF of the power of the communication device 200, and a touch panel formed on the display unit 206.

The display unit 206 displays moving image data, text for interactive operations, and the like. Note that the communication device 200 does not necessarily have to include the display unit 206. The communication device 200 can also be connected to the display unit 206, and need only have at least a display control function for controlling the display of the display unit 206. The display unit 206 is a device that displays images, such as a liquid crystal display device or an organic EL display device.

The recording medium 210 can record files including audio data and image data output from the image capturing unit 202. The recording medium 210 may be configured to be detachable from the communication device 200, or may be built into the communication device 200. In other words, the communication device 200 need only be able to at least access the recording medium 210.

The communication unit 211 is an interface for performing communication with an external device. The communication device 200 of the present embodiment transmits and receives data to and from the image capturing device 100 and the server 300 via the communication unit 211. In the present embodiment, the communication unit 211 is, for example, an antenna. The control unit 101 can be connected to the image capturing device 100 via the antenna of the communication unit 211. Note that the communication unit 211 may be connected to the image capturing device 100 and the server 300 directly or via an access point. The picture transfer protocol over internet protocol (PTP/P) performed via a wireless LAN can be used as the protocol for performing data communication.

The communication unit 211 also includes a universal serial bus (USB) interface that uses a USB cable for connecting to an external device. However, communication with external devices is not limited to this. For example, the communication unit 211 can include a wireless communication module such as an infrared communication module, a Bluetooth (registered trademark) communication module, or Wireless USB.

The public network connection unit 213 is an interface used when performing public wireless communication. The communication device 200 can make calls to other devices via the public network connection unit 213. At this time, the control unit 201 receives input of an audio signal via the microphone 214 and outputs the audio signal via the speaker 215, thereby realizing a call.

The communication device 200 of the present embodiment can transmit and receive data to and from the server 300 via the public network connection unit 213. The public network connection unit 213 is, for example, an antenna. The control unit 101 can connect to a public network via the antenna of the public network connection unit 213. Note that the communication unit 211 and the public network connection unit 213 may both use the same antenna. Generally, communication performed via the communication unit 211 has a faster communication speed than communication performed via a public network. Therefore, in the communication device 200 of the present embodiment, if no call is being made, communication via the communication unit 211 is prioritized.

Next, a software configuration diagram of the communication device 200 in the present embodiment will be described.

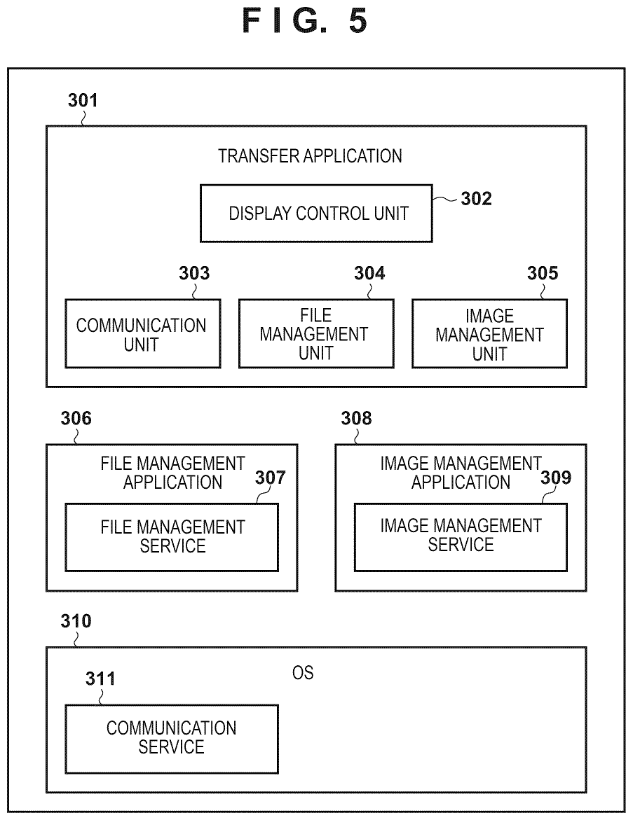

FIG. 5 is a functional block diagram showing the software configuration of the communication device 200. The non-volatile memory 203 of the communication device 200 stores various fixed data and firmware.

An OS 310, which is basic software executed by the control unit 201, and a file management application 306 and an image management application 308, which are application software executed by the control unit 201, are recorded on the recording medium 210. Moreover, as application software, a transfer application 301 having a function of connecting to the image capturing device 100, acquiring and saving files, and connecting to the server 300 to transfer files is recorded in the recording medium 210. The control unit 201 realizes the functions of the file management application 306, the image management application 308, and the transfer application 301 by, for example, reading a program stored in the recording medium 210.

When the user turns on the power switch included in the operation unit 205 of the communication device 200, the communication device 200 starts up. Accordingly, the control unit 201 reads the OS 310 from the recording medium 210, loads the OS into the working memory 204, and executes the OS. The control unit 201 also controls units of the communication device 200 in accordance with the OS 310 and applications installed on the OS.

Here, in the following description given with reference to the drawings, the control unit 201 executing predetermined processing in accordance with an application (or a function of an application, or the OS, or an OS service, or the like) may be expressed as “the application (or a function of an application, or the OS, or an OS service, or the like) performs predetermined processing”.

The OS 310 not only has a function of controlling units of the communication device 200, but also provides various services to applications. As a characteristic function of the present embodiment, the OS 310 has a communication service 311.

The communication service 311 controls the turning on and off of the communication function, and controls connection to an external device and data communication with a connected external device. The communication service 311 provides data obtained by the communication function to an application, and controls the transmission and reception of data to and from an external device in response to a request from the application.

The file management application 306 includes a file management service 307 that manages a list of files recorded on the recording medium 210. The file management application 306 controls the reading of files managed by a file management function from the recording medium 210, and the writing of files to the recording medium 210 in response to a request from an application.

The image management application 308 has an image management service 309 that manages a list of image files and moving image files recorded on the recording medium 210. Unlike the file management application 306, the image management application 308 has functions specialized for managing still image files and moving image files, such as a function for displaying a list of thumbnail images of still image files and moving image files, and a frame-by-frame playback function for moving image files.

The image management application 308 controls the reading of files managed by the image management function from the recording medium 210, and the writing of files to the recording medium 210 in response to a request from an application.

It is assumed here that the files managed by the file management application 306 and the files managed by the image management application 308 are managed in separate, independent areas of the recording medium 210 and cannot refer to each other.

Next, the transfer application 301, which is a characteristic feature of the present embodiment, will be described. The transfer application 301 includes a display control unit 302, a communication unit 303, a file management unit 304, and an image management unit 305.

The display control unit 302 generates screens to be displayed on the display unit 206. For example, the display control unit 302 generates file list screen, which is a screen including a list of files, and causes the display unit 206 to display the screen. Here, the display control unit 302 generates a file list screen that includes small images (e.g., thumbnail images or icons indicating the contents of files), file names (the names of the files), and file information. The file information is information regarding the file, including the recording date and time of the file, for example.

Here, the display control unit 302 changes the display of the recording date and time in the file information based on whether or not the storage date and time of the file to be displayed can be stored inside the file. The display control unit 302 may determine whether or not the storage date and time can be stored inside the file based on the format of the file. The display control unit 302 may acquire information regarding the file format from an external device (the image capturing device 100 in this case).

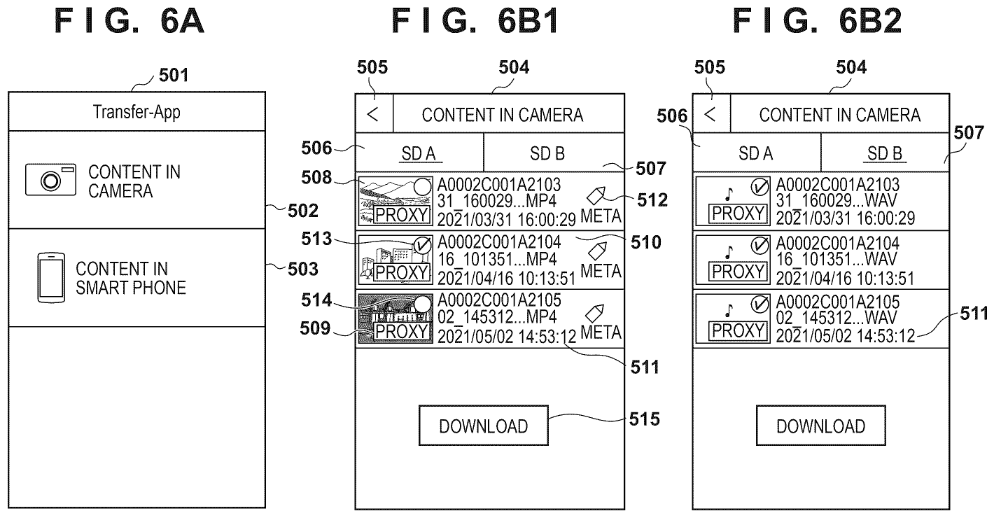

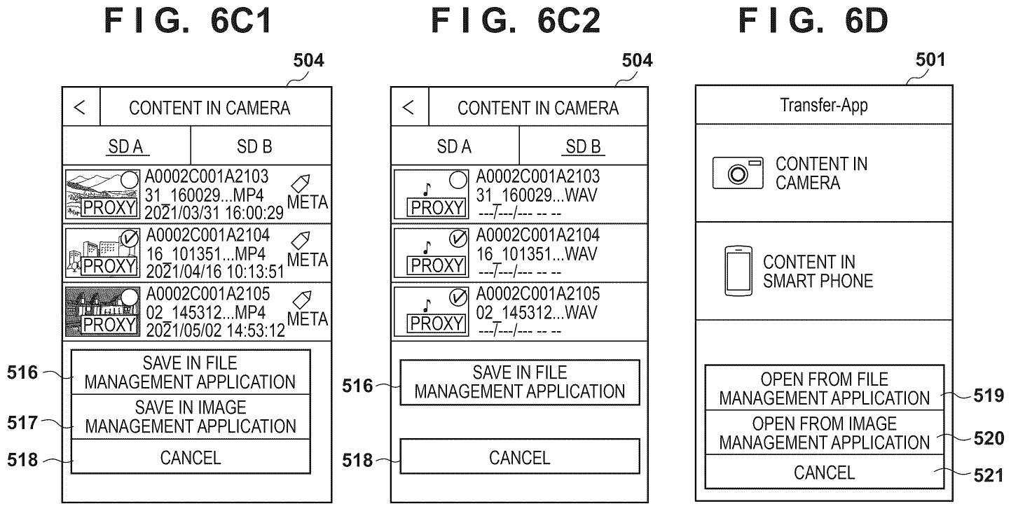

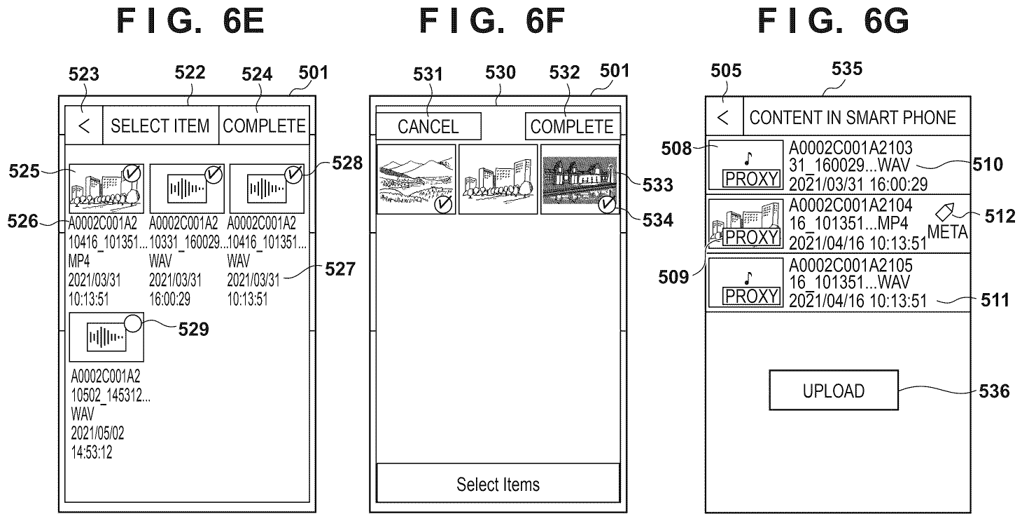

For example, in the case of a file in which the recording date and time can be recorded, the display control unit 302 generates a screen in which the file information includes the recording date and time included in the file. Examples of files in which the recording date and time can be recorded include image files such as still image files and moving image files in the MP4 format. On the other hand, in the case of a file in which the recording date and time cannot be stored, the display control unit 302 acquires the recording date and time from the file name of the file, and generates a screen in which the file information includes the acquired recording date and time. One example of a file in which the recording date and time cannot be stored is an audio file in the WAV format. The screen generated by the display control unit 302 will be described in detail later with reference to FIG. 6.

The communication unit 303 performs communication with the image capturing device 100 using the communication service 311, acquires file list information, file information, audio files, still image files, and moving image files recorded in the image capturing device 100. The communication unit 303 uses the communication service 311 to read out a file stored in the recording medium 210 and transmit the file to the server 300.

The file management unit 304 uses the file management service 307 to write and store, in the recording medium 210, still image files and moving image files held in the working memory 204.

The image management unit 305 uses the image management service 309 to write and store, in the recording medium 210, still image files and moving image files held in the working memory 204.

Next, operation screens and functions generated by the transfer application 301 will be described. FIGS. 6A to 6G show examples of operation screens generated by the transfer application 301. The display states of operation screens and functions generated by the transfer application 301 will be described below.

A function selection screen 501 shown in FIG. 6A is displayed while the transfer application 301 is connected to the image capturing device 100 after the transfer application 301 is started. The function selection screen 501 includes a select button 502 for selecting a function for displaying files recorded in the image capturing device 100, and a select button 503 for selecting a function for displaying files recorded on the recording medium 210 of the communication device 200.

A list display screen 504 shown in FIG. 6B1 and FIG. 6B2 displays a list of files recorded in the image capturing device 100 connected to the communication device 200. When the user taps the select button 502 on the function selection screen 501, the function selection screen 501 transitions to the list display screen 504.

A back button 505 is a button for returning to the previous screen. A select button 506 and a select button 507 are buttons for selecting and changing the recording medium 110 to be referred to in the case where there are multiple recording media 110 in the image capturing device 100. In the example of FIG. 6B1, the select button 506 with underlined characters is selected, and a list of files recorded on the recording medium 110 associated with the select button 506 is displayed. In the example of FIG. 6B2, the select button 507 is selected, and a list of files recorded on the recording medium 110 associated with the select button 507 is displayed. In the present embodiment, the recording medium 110 of the select button 506 stores moving image files. On the other hand, the recording medium 110 of the select button 507 stores audio files recorded at the same time as the moving image files.

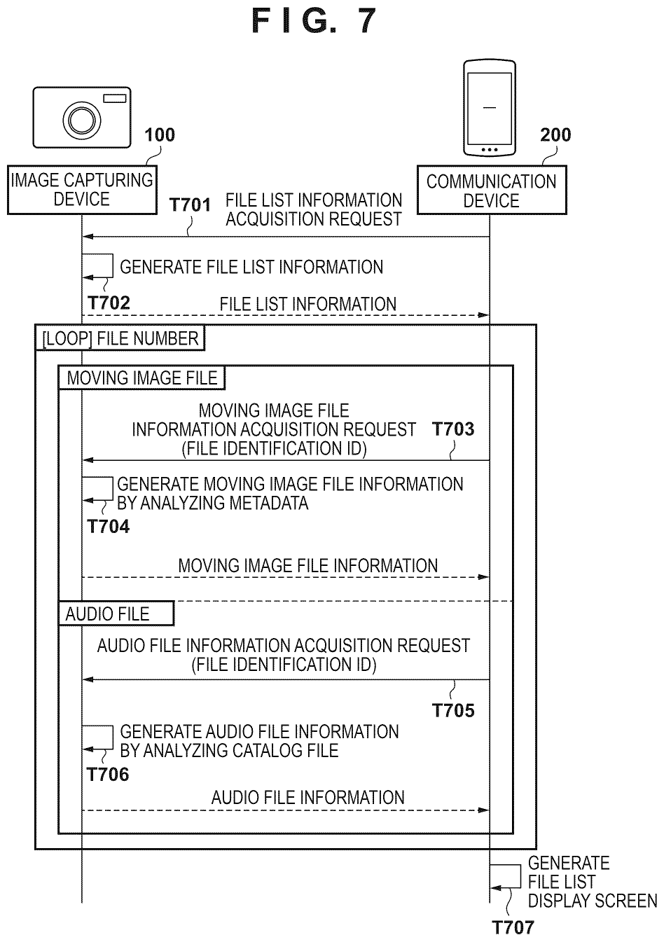

Components from an image 508 to an icon 512 in FIGS. 6B1 and 6B2 (b-2) are generated based on the file list information and the file information of the files recorded in the connected image capturing device 100. The components from the image 508 to the icon 512 are components whose display content is the same as the corresponding components in FIG. 6E, and therefore only the display content will be described below, and the method of acquiring file information for displaying the components from the image 508 to the icon 512 will be described later in the description of FIGS. 7 to 9B.

An image 508 is a small image showing the content of the file. For example, in the case of a moving image file, the image 508 is thumbnail image recorded in the moving image file, and in the case of an audio file, the image 508 is an image indicating that the file is an audio file stored in the non-volatile memory 203 in advance.

An icon 509 is an icon image indicating that the moving image file or the audio file is a proxy file. A proxy file is a file that has been made lighter by setting the bit rate and the resolution lower than a normal recording file. In the example of FIG. 6B1, all of the files have been recorded as proxy files, and therefore the icon 509 is superimposed on all of the thumbnail images.

The file name 510 is a character string indicating the name of the file. In the present embodiment, the file name can have up to a maximum of 46 characters. In the example shown in FIG. 6B1, the file names are long, and therefore due to the number of characters that the transfer application 301 can display, not all of the characters included in the file names are displayed. The file name 510 may include the recording date and time of the file.

Date and time information 511 is a character string indicating the recording date and time of the file. The date and time information 511 is an example of file information. The date and time information 511 is displayed together with the file name 510. Note that the date and time information 511 is displayed below the file name 510 and separately from the file name 510, but the display position and method may be changed as appropriate. In the example shown in FIG. 6B1, later-described metadata files exist on the recording medium 110 on which the moving image files are recorded. In this case, the control unit 201 acquires and displays the date and time information 511 from the metadata information. In the example of FIG. 6B2, the control unit 201 acquires the recording date and time included in the file name 510 of each of the audio files, and displays the recording date and time as the date and time information 511.

An icon 512 indicates whether a metadata file indicating metadata information of the moving image file exists on the same recording medium.

An icon 513 and an icon 514 indicate the selected/unselected state of a file. The icons 513 and 514 are displayed superimposed on the image 508. The icon 513 indicates the selected state. On the other hand, the icon 514 indicates the non-selected state. When the user taps an image 508 corresponding to a file, the file is switched between the selected and unselected states, and the displayed icons 513 and 514 are switched.

A download button 515 is a button for starting the saving of a file from the image capturing device 100 to the communication device 200. The file that is saved by operating the download button 515 is the file in the selected state with the icon 513 superimposed thereon.

When the user taps the download button 515 on the list display screen 504, a save button 516, a save button 517, and a cancel button 518 are displayed superimposed on the list display screen 504, as shown in FIG. 6C1 or FIG. 6C2. In FIG. 6C1 or 6C2 (c-2), the save button 516, the save button 517, and the cancel button 518 are buttons for selecting the destination application to which the file from the image capturing device 100 is to be saved.

The save button 516 is a button for selecting the file management application 306 as the save destination. When the user taps the save button 516, files recorded in the connected image capturing device 100 start to be saved to the file management application 306. Here, the files to be saved to the file management application 306 are the selected file and the metadata file related to the selected file.

The save button 517 is a button for selecting the image management application 308 as the save destination, and when tapped, a file recorded in the connected image capturing device 100 starts to be saved to the image management application 308. Here, the image management application 308 is an application capable of managing image files and moving image files, and therefore the file to be saved to the image management application 308 is only the selected moving image file.

The cancel button 518 is a button for canceling file saving. When the user taps the cancel button 518, the screen transitions to the list display screen 504 on which the download button 515 is superimposed.

An open button 519, an open button 520, and a cancel button 521 in FIG. 6D are buttons for selecting the source application from which a file is to be read from the recording medium 210. When the user taps the select button 503 on the function selection screen 501, the open button 519, the open button 520, and the cancel button 521 are displayed superimposed on the function selection screen 501.

The open button 519 is a button for selecting the file management application 306 as the read source. When the user taps the open button 519, the reading of a file from the file management application 306 starts. A selection screen for files to be managed by the file management application 306 will be described later with reference to FIG. 6E.

The open button 520 is a button for selecting the image management application 308 as the read source. When the user taps the open button 520, the reading of a file from the image management application 308 starts. A selection screen for files to be managed by the image management application 308 will be described later with reference to FIG. 6F.

The cancel button 521 is a button for canceling file reading. When the user taps the cancel button 521, the screen transitions to the function selection screen 501 in which the buttons 519 and 520 have been deleted.

A file selection screen 522 shown in FIG. 6E is a screen provided by the OS 310. On the file selection screen 522, the user selects a file to be read from among the files managed by the file management application 306. When the button 519 in FIG. 6D is tapped, the file selection screen 522 is displayed superimposed on the function selection screen 501. Here, it is assumed here that the files that can be selected are set to, for example, only moving image files in the MP4 format and audio files in the WAV format.

A back button 523 is a button for returning to the previous screen. When the user taps the back button 523, the screen transitions to the function selection screen 501.

A done button 524 is a button for completing file selection. When the user taps the done button 524, the screen transitions to a later-described selected file list screen 535.

An image 525 is a small image showing the content of the file. For example, in the case where the file is an image file such as a moving image file, the image 525 is a thumbnail image stored in the file. Therefore, when the user taps on the image 525 associated with an image file such as a moving image file, the transfer application 301 displays a thumbnail image recorded in the image file. On the other hand, if the tapped file is an audio file, the transfer application 301 displays an image 525 indicating that the file is an audio file stored in the non-volatile memory 203 in advance. The thumbnail image displayed in the image 525 is that of the file that was saved by tapping the save button 516 while the file with the checked icon 513 was selected in FIG. 6C1 or FIG. 6C2.

The file name 526 is a character string indicating the name of the file.

Date and time information 527 is a character string indicating the recording date and time of the file. The date and time information is an example of file information. When a file read from the recording medium 210 is to be displayed on the file selection screen 522, the control unit 201 determines the file type based on the format of the read file. Upon determining that the file type is a moving image file, the control unit 201 acquires recording date and time information from a metadata file indicating metadata information, and displays the acquired information in the date and time information 527, as the recording date and time of the moving image file. Upon determining that the file type is an audio file based on the file format, the control unit 201 acquires the recording date and time information from the file name, and displays the acquired information in the date and time information 527, as the recording date and time of the audio file.

An icon 528 and an icon 529 indicate the selected/unselected state of a file, and are displayed superimposed on the image 525. The icon 528 indicates the selected state in which a file is selected. The icon 529 indicates an unselected state in which the file is not selected. When the user taps an image 525 corresponding to a file, the file is switched between the selected and unselected states, and the displayed icons 528 and 529 are switched.

The file selection screen 530 shown in FIG. 6F is a screen provided by the control unit 201. On the file selection screen 530, the user selects a file to be read from among the moving image files managed by the image management application 308. When the open button 520 in FIG. 6D is tapped, the file selection screen 530 is displayed superimposed on the function selection screen 501. Here, it is assumed here that the files that can be selected are set to, for example, only moving image files.

A cancel button 531 is a button for canceling the file selection and returning to the previous screen. When the user taps the cancel button 531, the screen transitions to the function selection screen 501.

A done button 532 is a button for completing file selection. When the user taps the done button 532, the screen transitions to the later-described selected file list screen 535.

An image 533 is the same as image 525, and is a small image showing the content of the file, such as a thumbnail image.

An icon 534 indicates the selection state of a file. The icon 534 is displayed superimposed on the image 525. The icon 534 indicates the selected state, and is displayed only when the file is selected. When the user taps on the image 533 corresponding to a file, the file is switched between the selected and unselected states, and the icon 534 is switched between being displayed and hidden.

A selected file list screen 535 shown in FIG. 6G displays a list of files selected on the file selection screen 522 or the file selection screen 530. When the user taps the done button 524 or the done button 532, the file selection screen 522 or 530 transitions to the selected file list screen 535. In the present embodiment, the screen shown after the done button 524 is tapped is shown.

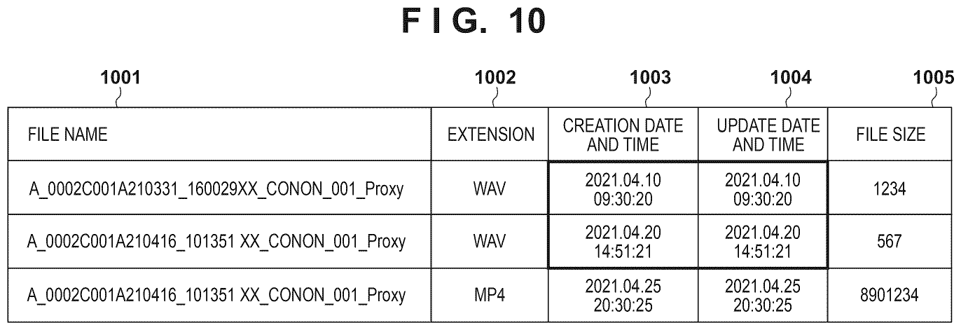

Components from the image 508 to the icon 512 in FIG. 6G are generated based on the file information of the selected files read from the recording medium 210. Note that the display content of the components from the image 508 to the icon 512 is similar to that in FIG. (b-1), and thus a description thereof will be omitted. A method for acquiring file information for displaying components from the image 508 to the icon 512 on this screen will be described later with reference to FIGS. 10 to 12.

The back button 505 is a button for returning to the previous screen. When the user taps the back button 505, the selected file list screen 535 transitions to the function selection screen 501.

An upload button 536 is a button for starting the transmission of a file from the communication device 200 to the server 300. The files that are to be transmitted when the upload button 536 is tapped are all of the files displayed on the selected file list screen 535.

Note that a function may be provided such that, from among the files recorded in the image capturing device 100, the files selected on the list display screen 504 can be transmitted to the server 300 without being saved in the communication device 200.

As described above, the transfer application 301 of the present embodiment has the following two main functions.

The first function is to perform communication with the image capturing device 100 and store, in the communication device 200, one or more files selected by the user from among the moving image files and audio files stored in the image capturing device 100.

The second function is to perform communication with the server 300 and transmit, to the server 300, one or more files selected from among the moving image files and audio files stored in the communication device 200.

That is, the main purpose of the transfer application 301 is to transfer moving image files and audio files recorded by the image capturing device 100 to the server 300 via the communication device 200 by using the two above-mentioned functions. Furthermore, the transfer application 301 accurately displays the file information of files in order to appropriately provide the user with these two functions.

Next, processing performed when the transfer application 301 of the communication device 200 displays the list display screen 504 of files recorded in the image capturing device 100 shown in FIG. 6B1 and FIG. 6B2 will be described with reference to FIGS. 7 to 9B.

FIG. 7 is a diagram showing a processing sequence for displaying the list display screen 504 on the communication device 200. Specifically, FIG. 7 shows a sequence of processing performed in the image capturing device 100 and the communication device 200 from when the communication device 200 detects that the user tapped the select button 502 on the function selection screen 501 in FIG. 6A until when the list display screen 504 is displayed.

In T701, the control unit 201 of the communication device 200 detects that the user tapped the select button 502 on the function selection screen 501 in FIG. 6A, and then transmits a file list information acquisition request to the image capturing device 100.

In T702, the control unit 101 of the image capturing device 100 receives the file list information acquisition request from the communication device 200, and then generates file list information based on file information stored in the recording medium 110. Here, the file list information includes a file name, a format, and an identification ID for each file. The identification ID is an identifier generated for each file in order to identify the file. The identification ID is used when making a request for a single file to the image capturing device 100, such as a request to acquire file information or a file itself.

After generating the file list information, the control unit 101 of the image capturing device 100 transmits the file list information to the communication device 200 as a response to the request in T701.

The control unit 201 of the communication device 200 receives the file list information, and, for each of the included files, refers to the format of the file, and executes the following processing according to the format.

If the file is in a moving image file format such as MP4, in T703 of FIG. 7, the control unit 201 of the communication device 200 transmits a moving image file information acquisition request to the image capturing device 100. At this time, the control unit 201 assigns an identification ID to specify the file for which moving image file information is to be acquired.

In T704 in FIG. 7, the control unit 101 of the image capturing device 100 receives the moving image file information acquisition request from the communication device 200, and generates moving image file information based on the information stored in the meta information storage area of the corresponding file.

Here, in the case of the MP4 file format, the meta information storage area includes the recording date and time as detailed information about the file, and in the present embodiment, the control unit 101 of the image capturing device 100 performs control such that a thumbnail image is stored in the meta information storage area when generating a moving image file.

Therefore, in T704, the control unit 101 of the image capturing device 100 generates the moving image file information so as to include at least a thumbnail image and a recording date and time. Furthermore, the control unit 101 of the image capturing device 100 adds information on whether or not an associated metadata file exists to the moving image file information.

After generating the moving image file information regarding the designated file, the control unit 101 of the image capturing device 100 transmits the moving image file information to the communication device 200 as a response to the request of T703.

In the case where the file is in an audio file format such as WAV, the control unit 201 of the communication device 200 transmits an audio file information acquisition request to the image capturing device 100 in T705 of FIG. 7. At this time, the control unit 201 assigns an identification ID to specify the file for which audio file information is to be acquired.

In T706 in FIG. 7, the control unit 101 of the image capturing device 100 receives the audio file information acquisition request from the communication device 200, and generates audio file information based on the file information in the catalog file stored in the recording medium 110.

Here, the file information in the catalog file includes the recording date and time as described above. The control unit 101 of the image capturing device 100 adds at least the recording date and time to the audio file information.

After generating the audio file information regarding the designated file, the control unit 101 of the image capturing device 100 transmits the audio file information to the communication device 200 as a response to the request of T703.

If the file format is neither MP4 nor WAV, the control unit 201 of the communication device 200 determines that the file is not to be displayed on the file list display screen 504, and does not execute processing related to the file information acquisition request.

Upon executing the processing related to the file information acquisition request according to the format for all of the above-described files and receiving a response, in T707 in FIG. 7, the control unit 201 of the communication device 200 generates a list display screen 504 based on the file list information, the moving image file information, and the audio file information acquired from the image capturing device 100.

Here, the files are arranged in the list display screen 504 in order from oldest to newest in terms of the recording date and time, for example. Note that the order of the files may be changed as appropriate by the user performing a setting change.

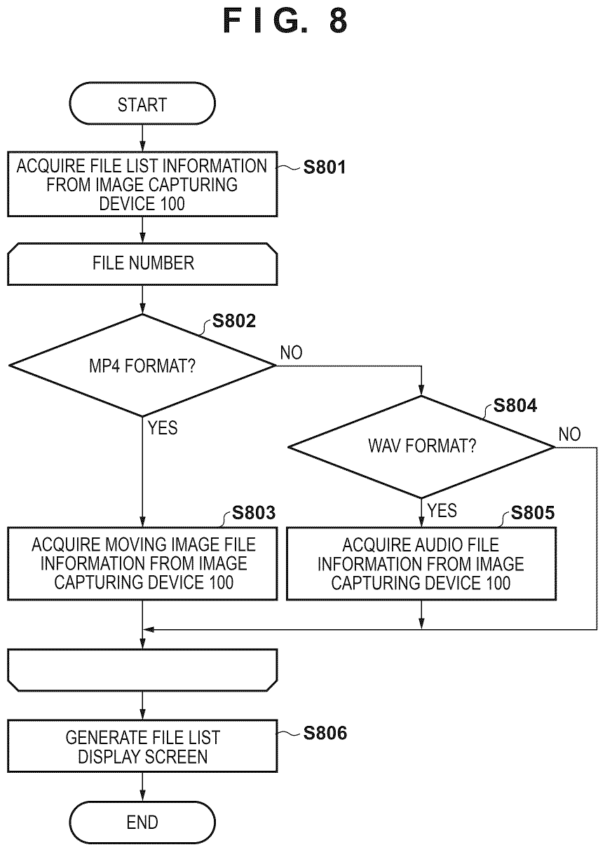

Next, a flow of processing in which the control unit 201 of the communication device 200 generates the list display screen 504 of files recorded in the image capturing device 100 will be described. FIG. 8 shows a flow of processing for generating the list display screen 504 executed by the control unit 201 of the communication device 200. The control unit 201 of the communication device 200 executes the processing flow shown in FIG. 8 in response to detection of a tap on the select button 502 on the operation unit 205 while the function selection screen 501 of FIG. 6A is being displayed in the transfer application 301. The control unit 201 loads a program to cause the transfer application 301 to function and execute the following steps.

In step S801 of FIG. 8, the control unit 201 of the communication device 200 requests, via the communication unit 303, the acquisition of file list information from the image capturing device 100 in order to display the list display screen 504 of files recorded in the image capturing device 100.

After acquiring the file list information from the image capturing device 100, the control unit 201 executes the processing shown in steps S802 to S805 for all files included in the file list information.

In step S802, the control unit 201 determines whether or not the file format is MP4. If the control unit 201 determines that the file format is MP4, the processing moves to step S803, and if the control unit 201 determines that the file format is not MP4, the processing moves to step S804.

In S803, the control unit 201 transmits a moving image file information acquisition request to the image capturing device 100, and acquires moving image file information from the image capturing device 100.

In step S804, the control unit 201 refers to the file list information and determines whether or not the file format is WAV. In the case of determining that the file format is WAV, the control unit 201 moves to step S805, and in the case of determining that the file format is not WAV, processing for that file is ended.

In S805, the control unit 201 transmits an audio file information acquisition request to the image capturing device 100, and acquires audio file information from the image capturing device 100.

The control unit 201 executes the above-described processing of steps S802 to S804 for all files, thereby acquiring file information required for generating the file list display screen 504 from the image capturing device 100.

In step S806 in FIG. 8, the control unit 201 generates components from the image 508 to the icon 512 of the list display screen 504 shown in FIG. 6B based on the file list information, the moving image file information, and the audio file information acquired from the image capturing device 100.

Through the above processing, the control unit 201 generates the list display screen 504 of files recorded in the image capturing device 100.

### Image Capturing Device Processing Flow

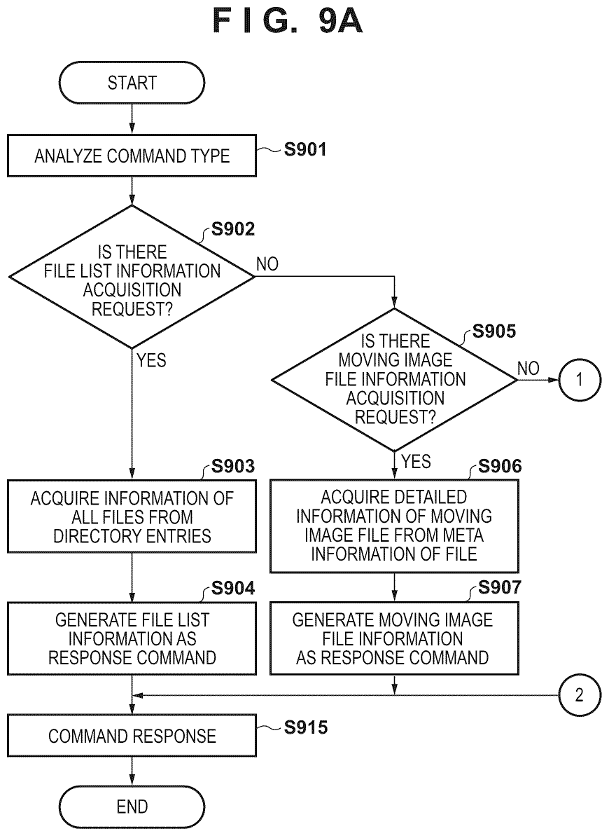

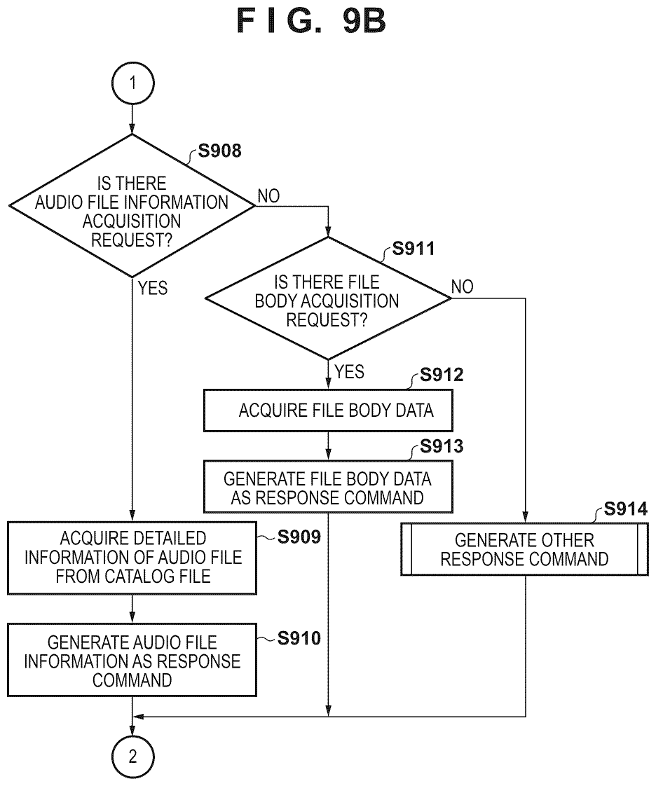

Next, a flow of processing performed by the image capturing device 100 when a communication command is received from an external device such as the communication device 200 will be described. FIGS. 9A and 9B shows a flow of processing executed by the control unit 101 of the image capturing device 100 when a communication command is received. The control unit 101 executes the processing flow shown in FIGS. 9A and 9B when the communication unit 111 receives a PTP/IP communication command from an external device.

In step S901 of FIGS. 9A and 9B, the control unit 101 of the image capturing device 100 analyzes the type of the PTP/IP communication command received by the communication unit 111.

In step S902, if the control unit 101 determines that the command type is a file list information acquisition request, the processing moves to step S903.

In step S903, the control unit 101 analyzes the directory entries of the recording medium 110 and acquires file information for all files stored in the recording medium 110.

In step S904, the control unit 101 generates an identification ID for each file from the acquired file information, and generates file list information including a file name, a format, and an identification ID for each file, as a response command.

In step S902, if the control unit 101 determines that the command type is not a file list information acquisition request, the processing moves to step S905.

In step S905, if the control unit 101 determines that the command type is a moving image file information acquisition request, the processing moves to step S906.

In step S906, the control unit 101 refers to the meta information storage area of the moving image file designated by the identification ID, and acquires detailed information regarding the moving image file, including a thumbnail image and the recording date and time, as file information.

In step S907, the control unit 101 generates, as a response command, moving image file information including the thumbnail image and the recording date and time from the acquired detailed information regarding the moving image file.

In step S905, if the control unit 101 determines that the command type is not a moving image file information acquisition request, the processing moves to step S908.

In step S908, if the control unit 101 determines that the command type is an audio file information acquisition request, the processing moves to step S909.

In step S909, the control unit 101 refers to the information in the catalog file recorded on the recording medium 110, and acquires detailed information including the recording date and time of the audio file designated by the identification ID.

In step S910, the control unit 101 generates, as a response command, audio file information including the recording date and time from the acquired detailed information regarding the audio file.

In step S908, if the control unit 101 determines that the command type is not an audio file information acquisition request, the processing moves to step S911.

In step S911, if the control unit 101 determines that the command type is a file acquisition request, the processing moves to step S912.

In step S912, the control unit 101 acquires the body data of the file designated by the identification ID.

In step S913, the control unit 101 generates the body data of the acquired file as a response command.

In step S911, if the control unit 101 determines that the command type is not a file acquisition request, the processing moves to step S914.

In step S914, the control unit 101 executes processing corresponding to a command type not included in the above, and generates a response command. Note that the processing of step S914 is not necessary for implementing the present embodiment, and therefore a detailed description thereof will be omitted.

In step S915, the control unit 101 transmits the generated response command to the external device that is the source of the communication command (e.g., the communication device 200), via the communication unit 111.

Through the above processing, the image capturing device 100 exchanges file information and files with an external device such as the communication device 200 via the communication unit 111.

### Overview of Processing For Saving File to Communication Device

Next, processing by which a file recorded in the image capturing device 100 is saved to the recording medium 210 of the communication device 200 will be described.

The user selects a file that is to be saved to the communication device 200 on the list display screen 504 of files recorded in the image capturing device 100 shown in FIGS. 6B1 and 6B2.

After completing the selection operation, the user taps the download button 515, and then taps the save button 516 or the save button 517 in FIG. 6C1 or 6C2. Thereafter, the user selects either the file management application 306 or the image management application 308 as the file save destination.

When the user selects a destination application, the control unit 201 of the communication device 200 acquires the selected file from the image capturing device 100 and writes the acquired file to the management area for the destination application on the recording medium 210.

### Directory Entry

FIG. 10 is a diagram schematically showing directory entries. The directory entries are stored on the recording medium 210 by the file management application 306.

The directory entries shown in FIG. 10 include information regarding files managed by the file management application 306. Specifically, each of the directory entries includes a file name 1001, an extension 1002, a creation date and time 1003, an update date and time 1004, and a file size 1005, as file information.

FIG. 10 shows directory entries in the case where a file acquired from the outside is written to the file management application 306.

When writing a file acquired from the outside, the file management application 306 writes the writing date and time of the file as the creation date and time and the update date and time in the directory entry. That is, a date and time different from the recording date and time held by the image capturing device 100 is written as the creation date and time and the update date and time of the directory entry. Depending on the OS specifications and the writing method, there are cases where only the creation date and time or the update date and time is updated to the writing date and time, and cases where both are updated to the writing date and time.

As described above, if the control unit 201 of the communication device 200 displays the creation date and time or the update date and time of a directory entry as-is as the recording date and time of an audio file on the file selection screen 522 and the selected file list screen 535, the writing date and time of the file is displayed, rather than the accurate recording date and time of the file. Therefore, in the present embodiment, as described above in the description of the date and time information 527, the file name of the audio file is analyzed to acquire recording date and time information, and the acquired recording date and time information is displayed as the date and time information 527 of the audio file.

### Processing For Displaying List of Files Recorded in Communication Device

Next, processing for retrieving files from the file management application 306 and generating a selected file list screen 535 showing selected files will be described.

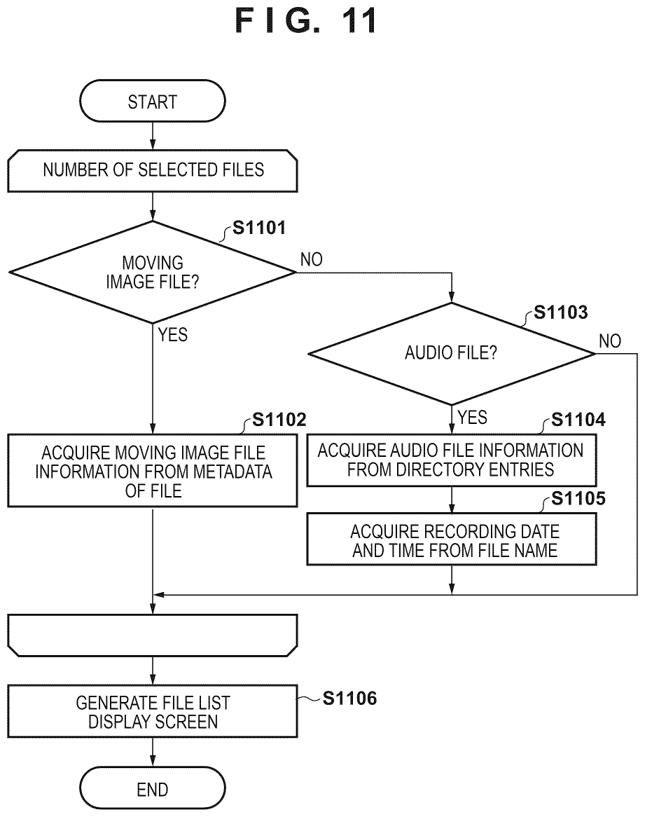

FIG. 11 shows a flow of processing executed by the control unit 201 of the communication device 200 to generate a selected file list screen. One or more files are selected by the user in the file selection screen 522 from the file management application shown in FIG. 6E. In this state, when the operation unit 205 detects a tap on the done button 524 (i.e., detects that the selection of files to be displayed is complete), the control unit 201 executes the flow of processing for generating the selected file list screen 535 in FIG. 11. The control unit 201 loads a program to cause the transfer application 301 to function and execute the following steps.

First, the control unit 201 executes the processing shown in steps S1101 to S1105 for all the selected files.

In step S1101, the control unit 201 determines whether or not the file is a moving image file based on the file format or the like.

In step S1101, if the control unit 201 determines that the file format is MP4 and that the file is a moving image file, the processing moves to step S1102.

In step S1102, the control unit 201 analyzes the meta information storage area of the file to acquire moving image file information including a thumbnail image and the recording date and time of the file.

In step S1101, if the control unit 201 determines that the file is not a moving image file, the processing moves to step S1103.

In step S1103, the control unit 201 determines whether or not the file is an audio file based on the format of the file.

In step S1103, if the control unit 201 determines that the file format is WAV and that the file is an audio file, the processing moves to step S1104.

In step S1104, the control unit 201 refers to the corresponding directory entry of the file management application 306 to acquire audio file information other than the creation date and time 1003 and the update date and time 1004.

In step S1105, the control unit 201 acquires the recording date and time information of the audio file from the file name, and interprets the acquired recording date and time information as the creation date and time 1003 and the update date and time 1004. Therefore, when retrieving a file, even if the file is in an audio format, it is possible to acquire an accurate recording date and time by referring to the file name.

In step S1103, if the control unit 201 determines that the file is not an audio file, processing for that file is ended.

The control unit 201 executes the above-described processing of steps S1101 to S1105 for all files, thereby acquiring information required to generate the selected file list screen 535 from the file management application 306.

In step S1106 of FIG. 11, the control unit 201 generates the selected file list screen 535 shown in FIG. 6G from the moving image file information and the audio file acquired from the file management application 306.

Here, the files in the selected file list screen 535 are arranged in order from oldest to newest in terms of the recording date and time.

Through the above processing, when displaying a list display screen of files stored in the file management application 306, even when a file is an audio file whose recording date and time cannot be stored in the file, the control unit 201 can display an accurate recording date and time by acquiring the recording date and time from the file name.

### Other Embodiments

In the above embodiment, an example of handling an audio file in the WAV file format has been described, but the present embodiment may also be applied to the handling of other file formats in which the recording date and time cannot be stored inside the file.

In the above embodiment, an example of handling a moving image file in the MP4 file format has been described, but the present embodiment may also be applied to the handling of other file formats in which the recording date and time can be stored inside the file, such as still image files.

Furthermore, in the above embodiment, an audio file has been described as a file format in which the recording date and time cannot be stored, but there is no limitation to being an audio file, and the file need only be a file in which the recording date and time cannot be stored. For example, even when handling a metadata file in an XML file format that is generated when capturing a moving image, processing similar to that for an audio file may be performed.

In addition, in the above-described embodiment, the control unit 201 determines whether or not a file has a recording date and time based on the file format, but in order to be able to handle a file in an original format, for example, the control unit 101 may manage the presence or absence of a recording date and time for each file using a managing means such as a catalog file. In this case, the image capturing device 100 and the communication device 200 may have a managing means for managing information on whether or not the creation date and time and the update date and time have been updated when a file is saved to a terminal, and for referring to such information when reading a file from a terminal.

A configuration is possible in which, if a file is in a format in which the recording date and time cannot be stored inside the file, and furthermore the recording date and time is not included in the file name, the control unit 201 does not display a recording date and time for that file. This makes it possible to prevent the case where the control unit 201 acquires, from the catalog file, a creation date and time or an update date and time that is different from the recording date and time, and displays the acquired information as the recording date and time.

Furthermore, in the above-described embodiment, all audio files recorded on the recording medium 210 are displayed by the control unit 201 on the file list display screen 504 as shown in FIG. 6B2, but control may be performed such that, for example, if there is an audio file (an example of a first audio file) that has the same file name as a still image file and is recorded on the same recording medium 210 as the still image file, and there is an audio file (an example of a second audio file) recorded on a recording medium other than the recording medium on which a moving image file is recorded, the control unit 201 does not acquire the recording date and time from the file name of the former audio file, and does not display the former audio file on the file list display screen 504. Note that the former audio file is audio data that the user later adds to a JPEG image that has already been captured (also called an audio memo). The latter audio file is audio data that is stored separately as an audio-only file when a moving image file is captured. Note that there are cases where these audio files are in the same format (e.g. WAV).

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-017435, filed Feb. 7, 2024, which is hereby incorporated by reference herein in its entirety.

What is claimed is:

1. An information processing device comprising:
a storage unit configured to store file information regarding a file; and
a control unit configured to acquire the file information and display the file information and a file name on a display unit,
wherein in a case where the file is a file inside which a recording date and time cannot be stored, the control unit acquires a recording date and time from the file name of the file, adds the acquired recording date and time to the file information, and displays the file information on the display unit.

2. The information processing device according to claim 1,
wherein the control unit determines whether or not the file is a file inside which the recording date and time can be stored, based on a format of the file.

3. The information processing device according to claim 1,
wherein the control unit determines whether or not the file is a file inside which the recording date and time can be stored, based on whether or not the file is an audio file.

4. The information processing device according to claim 1,
wherein the control unit determines whether or not the file is a file inside which the recording date and time can be stored, based on whether or not the file is an image file.

5. The information processing device according to claim 1,
wherein the control unit acquires, from an external device, information indicating whether or not the file is a file inside which the recording date and time can be stored.

6. The information processing device according to claim 1,
wherein in a case where the control unit determines that the file is an image file, the control unit acquires the recording date and time stored inside the file.

7. The information processing device according to claim 1,
wherein in a case where the file is a file inside which the recording date and time cannot be stored, and furthermore the recording date and time is not included in the file name, the control unit does not display a recording date and time for the file in the file information the display unit.

8. The information processing device according to claim 1,
wherein the storage unit includes a plurality of storage units, and
out of a first audio file having the same file name as a still image file and stored in the same storage unit as the still image file, and a second audio file stored in a storage unit different from a storage unit in which a moving image file is stored, the control unit does not display the first audio file and file information of the first audio file on the display unit.

9. The information processing device according to claim 1,
wherein the control unit transfers, to an external device, a file selected by a user from among one or more files displayed together with the file information.

10. An information processing method comprising:
storing file information regarding a file; and
acquiring the file information and displaying the file information and a file name on a display unit,
wherein in the displaying, in a case where the file is a file inside which a recording date and time cannot be stored, a recording date and time is acquired from the file name of the file, the acquired recording date and time is added to the file information, and the acquired recording date and time is displayed on a display unit.

11. A non-transitory computer-readable storage medium storing a computer program that, when read and executed by a computer including a storage unit storing file information regarding a file, causes the computer to function as:
a control unit configured to acquire the file information and display the file information and a file name on a display unit,
wherein in a case where the file is a file inside which a recording date and time cannot be stored, the control unit acquires a recording date and time from the file name of the file, adds the acquired recording date and time to the file information, and displays the acquired recording date and time on the display unit.
